(19) United States
(12) Patent Application Publication
(10) Pub. No.: US 2003/0215149 A1
(43) Pub. Date: Nov. 20, 2003

(54) Color characteristic quantity processor, and color characteristic quantity processing method

(76) Inventor: Etsuko Sugimoto, Osaka (JP)

Correspondence Address: MCDERMOTT WILL & EMERY, 600 13TH STREET, N.W., WASHINGTON, DC, 20005-3096, US

(21) Appl. No.: 10/395,698

(22) Filed: Mar. 25, 2003

(30) Foreign Application Priority Data
Mar. 25, 2002 (JP) 2002-082863

(51) Int. Cl. G06K 9/36; G06K 9/46

(52) U.S. Cl. 382/233; 382/286

(57) ABSTRACT

A color characteristic quantity processor capable of reducing the volume of processing at the time of computation of a color descriptor and miniaturizing the processor by minimizing image memory for storing decoded data. A VLD section 12 outputs only DC component data among decoded data, and the data are inversely-quantized by an IQ section 14. In the case of an intra frame coded image, an output from the IQ section 13 is stored in image memory 16 without modification. In the case of an inter frame coded image, data which have been subjected to motion compensation performed by an MC section 18 and an addition section 20 are stored. A frame division section 22 divides the data stored in the image memory 16 into 64 (8×8) areas. In each of the areas, a mean value of the data is computed. An 8×8 DCT section 24 subjects the 64 mean values to DCT, and a predetermined number of DCT coefficients from the top are stored as color descriptors in a color characteristic quantity data holding section 28.

### BACKGROUND OF THE INVENTION

1. Field of the Invention

The invention relates to a color characteristic quantity processor and a color characteristic quantity processing method for computing a color characteristic quantity from image data, and more particularly, to a device and method for computing a color descriptor.

2. Description of the Related Art

When a color characteristic quantity is computed from a video image contents or static image contents, a color descriptor employed for ISO/IEC 15938-3 MPEG-7 Visual (hereinafter simply called “MPEG-7”) is taken as a color characteristic quantity.

The color descriptor has hitherto been computed in the following manner. Specifically, each frame of a static or motion video is divided into 64 aggregates of pixels [8 (equal) rows and 8 (equal) columns ]. In relation to the aggregates of pixels, a mean value of the pixels is determined. The aggregate of 64 mean values is subjected to a two-dimensional DCT (Discrete Cosine Transform) on the basis of two-dimensional spatial positions. From among coefficients output as a result of the two-dimensional DCT, several coefficients from the top are taken as color descriptors.

A conventional color characteristic quantity processor which computes a color descriptor is constructed as shown in FIG. 1. Specifically, a color characteristic quantity processing device B has an image data storage section 110, a VLD (Variable Length Decoder) section 112, an I-Scan (Inverse Scan) section 113, an IQ (Inverse Quantization) section 114, an IDCT (Inverse Discrete Cosine Transform) section 115, image memory 116, an MC (Motion Compensation) section 118, an addition section 120, a frame division section 122, an 8×8 DCT section 124, a scan section 126, and a color characteristic quantity data holding section 128.

Here, the image memory 116 is configured so as to store pixel value data corresponding to one frame of image data stored in the image data storage section 110.

In the color characteristic quantity processor B having the configuration shown in FIG. 1, the VLD section 112 subjects the image data stored in the image data storage section 110 to variable-length decoding. Subsequently, the I-Scan section 113 arranges the resultant data in a different sequence. Specifically, the data are arranged on the basis of each of the 8×8 aggregates of pixels (hereinafter called a “per-8×8-pixel basis”), and the thus-arranged data are sent to the IQ section 114. The IQ section 114 subjects the data to inverse quantization on a per-8×8-pixel basis. The thus-quantized data are sent to the IDCT section 115. The IDCT section 115 subjects the data to inverse DCT, whereupon the data are stored in the image memory 116. In the case of an intra frame coded image, such as an I-picture [or an I-VOP (Video Object Plane)], an output from the IDCT section 115 is stored in the image memory 116 without modification. However, in the case of an inter frame coded image, such as a P-picture or a B-picture (or P-VOP or B-VOP), the MC section 118, which performs motion compensation, extracts a pixel value of a reference frame from the image memory 116 on the basis of a motion vector output from the VLD section 112, and the thus-extracted pixel value is sent to the addition section 120. The addition section 120 adds the value output from the IDCT section 115 to the pixel value of the reference frame, and the result of addition is stored in the image memory 116. When the size of one frame in the image data storage section 110 is 704×480 pixels, a matrix-shaped memory area corresponding to a size of 704×480 pixels is prepared in the image memory 116. A value of 704×480 pixels is stored as data for one frame (see (1) in FIG. 2).

The frame division section 122 divides the pixel value corresponding to one frame into 64(8×8) divided regions (one divided region assumes 88×60 pixels) (see (2) in FIG. 2). The frame division section 122 further computes for each divided region (see (3) in FIG. 2). In short, 64mean values are computed.

The mean values are subjected to two-dimensional DCT processing to be performed by the 8×8 DCT section 124 (see ( 4) in FIG. 2) . From the DCT coefficients computed through DCT processing, several coefficients are scanned by the scan section 126, and the result of scanning is stored in the color characteristic quantity data retaining section 128.

In relation to MPEG-7, the color descriptor is computed for each of the three-dimensional color space axes (Y, Cb, and Cr).

As mentioned above, the color descriptor employed in MPEG-7 is usually computed after coded image data have been subjected to decoding operation, which comprises variable-length decoding, inverse scanning, inverse quantization and IDCT and so on. However, the decoding operation to be performed for computing the color descriptor involves a large volume of processing. Further, image memory (image memory 116 shown in FIG. 1) for storing a decoded image requires a large memory area.

### SUMMARY OF THE INVENTION

Accordingly, the invention provides a color characteristic quantity processor capable of reducing the volume of processing at the time of computation of a color descriptors as well as enabling miniaturization of the processor by minimizing image memory for storing decoded data.

The invention has been conceived to achieve the object and provides a color characteristic quantity processor for computing color characteristic quantity of image data, comprising:

decoding means for decoding MPEG-coded image data;

extraction means for extracting only DC component data from the data decoded by the decoding means;

inverse quantization means for subjecting the DC component data extracted by the extraction means to inverse quantization;

motion compensation means for subjecting the data that have been inversely quantized by the inverse quantization means to motion compensation;

storage means for storing the data that have been inversely quantized by the inverse quantization means and the data that have been subjected to motion compensation performed by the motion compensation means;

division means which divides, into a plurality of areas, data which are stored in the storage means and correspond to image data for one frame;

mean value computation means for computing a mean value of each data set in the respective areas divided by the division means; and

DCT means for subjecting the mean values computed by the mean value computation means to DCT.

According to the color characteristic quantity processor, the decoding means decodes MPEG-coded image data. For example, the decoding means subjects the image data to variable-length decoding. The extraction means extracts only DC component data from the data decoded by the decoding means. The inverse quantization means subjects the DC component data extracted by the extraction means to inverse quantization. The motion compensation means subjects the data that have been inversely quantized by the inverse quantization means to motion compensation. The storage means stores the data that have been inversely quantized by the inverse quantization means and the data that have been subjected to motion compensation performed by the motion compensation means. For example, in the case of an intra frame coded image, the data that have been inversely quantized by the inverse quantization means are stored without modification. In the case of an inter frame coded image, the data that have been subjected to motion compensation performed by the motion compensation means are stored.

The division means divides, into a plurality of areas, data which are stored in the storage means and correspond to image data for one frame. The mean value computation means computes a mean value of each data set in the respective areas divided by the division means. The DCT means subjects the mean values computed by the mean value computation means to DCT. Among the DCT coefficients obtained through DCT, a predetermined number of DCT coefficients from the top are stored as color descriptors.

The color characteristic quantity processor is not provided with the IDCT section, which is provided for the conventional the color characteristic quantity processor. Therefore, there is no necessity for performing an inverse DCT. Even at the time of computation of the mean value, the only requirement is to average data which are of one-sixty-fourth the volume required conventionally, thereby diminishing the volume of processing. Since means for effecting IDCT is not required, the overall processor can be miniaturized, thereby curtailing the cost of the processor.

In relation to the above-described configuration, the function of the extraction means may be imparted to the decoding means. Specifically, the configuration of the processor is changed as follows: namely, “a color characteristic quantity processor for computing color characteristic quantity of image data, comprising: decoding means for decoding MPEG-coded image data and extracting only DC component data from the decoded data; inverse quantization means for subjecting the DC component data extracted by the extraction means to inverse quantization; motion compensation means for subjecting the data that have been inversely quantized by the inverse quantization means to motion compensation; storage means for storing the data that have been inversely quantized by the inverse quantization means and the data that have been subjected to motion compensation performed by the motion compensation means; division means which divides, into a plurality of areas, data which are stored in the storage means and correspond to image data for one frame; mean value computation means for computing a mean value of each data set in the respective areas divided by the division means; and DCT means for subjecting to the mean values computed by the mean value computation means.”

In relation to the configuration, the function of the extraction means may be imparted to the inverse quantization means. Specifically, the color characteristic quantity processor may be configured as follows: “a color characteristic quantity processor for computing color characteristic quantity of image data, comprising: decoding means for decoding MPEG-coded image data; inverse quantization means for extracting only DC component data from the data decoded by the decoding means and subjecting the DC component data extracted by the extraction means to inverse quantization; motion compensation means for subjecting the data that have been inversely quantized by the inverse quantization means to motion compensation; storage means for storing the data that have been inversely quantized by the inverse quantization means and the data that have been subjected to motion compensation performed by the motion compensation means; division means which divides, into a plurality of areas, data which are stored in the storage means and correspond to image data for one frame; mean value computation means for computing a mean value of each data set in the respective areas divided by the division means; and DCT means for subjecting to DCT the mean values computed by the mean value computation means.”

In relation to the configuration, when image data serving objects of processing is intra frame coded image which do not refer to other frame data, the inverse quantization means preferably stores, into the storage means, data obtained through inverse quantization of the intra frame coded image. In the meantime, when image data serving objects of processing is inter frame coded image which refer to other frame data, the inverse quantization means preferably sends data obtained through inverse quantization of the inter frame coded image to the motion compensation means and the motion compensation means stores the data into the storage means after the motion compensation means has subjected the data to motion compensation.

In relation to the configuration, the color characteristic quantity processor preferably further comprises second storage means for storing, as color descriptors, a predetermined number of coefficients from the top among coefficients obtained by the DCT means.

In relation to the configuration, the division means preferably divides an aggregate of data in which data corresponding to image data for one frame are arranged in a matrix pattern into a total of 64 areas; that is, eight equal parts in the vertical and horizontal directions, and the mean value computation means preferably computes a mean value of values represented by the data sets in the respective areas.

In relation to the configuration, when the number of pixels in a longitudinal and/or lateral direction of image data for one frame is not a multiple of 8 and when data spreading across other areas are obtained as a result of the division means having divided the image data into a plurality of areas, the mean value computation means preferably computes the mean value by assigning weights to the data.

The invention provides a color characteristic quantity processor for computing color characteristic quantity of image data having a storage device for storing data, and a controller for performing:

decoding processing for decoding MPEG-coded image data;

extraction processing for extracting only DC component data from the data decoded by the decoding processing;

inverse quantization processing for subjecting the DC component data extracted by the extraction processing to inverse quantization;

storage processing for storing, into the storage device, the data inversely quantized by the inversely-quantized when image data serving objects of processing is intra frame coded image which do not refer to other frame data;

motion compensation processing for subjecting the data that have been inversely quantized by the inverse quantization processing to motion compensation when image data serving objects of processing is inter frame coded image which refer to other frame data;

second storage processing for storing into the storage device the data that have been subjected to motion compensation through the motion compensation processing;

division processing for dividing, into a plurality of areas, data which are stored in the storage device and correspond to image data for one frame;

mean value computation processing for computing a mean value of each data set in the respective areas divided by the division processing; and

DCT processing for subjecting the mean values computed by the mean value computation processing to DCT.

According to the color characteristic quantity processor, the controller decodes MPEG-coded image data by means of decoding processing. For example, the controller subjects the image data to variable-length decoding. By means of the extraction processing, the controller extracts only DC component data from the data decoded by means of the decoding processing. By means of the inverse quantization processing, the controller subjects the DC component data extracted through the extraction processing to inverse quantization. When image data serving objects of processing is intra frame coded image which do not refer to other frame data, the controller stores the data that have been inversely quantized through inverse quantization processing through the storage processing. When image data serving objects of processing is inter frame coded image which refer to other frame data, the controller subjects the data which have been inversely-quantized through the inverse quantization processing to motion compensation. Through the second storage processing, the data which have been subjected to motion compensation through the motion compensation processing are stored in the storage device. Through division processing, the controller divides, into a plurality of areas, data which are stored in the storage device and correspond to image data for one frame. By means of the mean value computation processing, the controller computes a mean value of each data set in the respective areas divided by the division processing. Further, through DCT processing, the controller subjects the mean values computed by the mean value computation processing to DCT. Among the coefficients obtained through DCT, the controller stores a predetermined number of DCT coefficients from the top as color descriptors.

The color characteristic quantity processor is not provided with the IDCT section, which is provided for the conventional color characteristic quantity processor. Therefore, there is no necessity for performing inverse DCT. Even at the time of computation of the mean value, the only requirement is to average data which are of one-sixty-fourth the volume required conventionally, thereby diminishing the volume of processing. Since means for effecting IDCT is not required, the overall processor can be miniaturized, thereby curtailing the cost of the processor.

In relation to the configuration, the color characteristic quantity processor preferably further comprises a second storage device, and the controller stores, as color descriptors into the second storage device, a predetermined number of coefficients from the top among coefficients obtained by the DCT processing.

In relation to the configuration, the controller preferably divides an aggregate of data in which data corresponding to image data for one frame are arranged in a matrix pattern into a total of 64 areas; that is, eight equal parts in the vertical and horizontal directions, through the division processing, and computes a mean value of values represented by the data sets in the respective areas through mean value computation processing.

In relation to the configuration, when the number of pixels in a longitudinal and/or lateral direction of image data for one frame is not a multiple of 8 and when data spreading across other areas are obtained as a result of the division processing having divided the image data into a plurality of areas, the controller preferably computes the mean value by assigning weights to the data.

The invention also provides a color characteristic quantity computation method for computing color characteristic quantity of image data, comprising:

a decoding step of decoding MPEG-coded image data;

an extraction step of extracting only DC component data from the data decoded in the decoding step;

an inverse quantization step of subjecting the DC component data extracted in the extraction step to inverse quantization;

a motion compensation step of subjecting the data that have been inversely quantized in the inverse quantization step to motion compensation;

a storage step of storing the data that have been inversely quantized in the inverse quantization step and the data that have been subjected to motion compensation performed in the motion compensation step;

a division step of dividing, into a plurality of areas, data which are stored in the storage step and correspond to image data for one frame;

a mean value computation step of computing a mean value of each data set in the respective areas divided in the division step; and

a DCT step of subjecting the mean values computed in the mean value computation step to DCT.

According to the color characteristic quantity computation method having the foregoing configuration, MPEG-coded image data are decoded through the decoding step. For example, image data are subjected to, e.g., variable-length decoding. In the extraction step, only DC component data are extracted from the data decoded in the decoding step. In the inverse quantization step, the DC component data extracted in the extraction step are inversely quantized. In the motion compensation step, the data that have been inversely quantized in the inverse quantization step are subjected to motion compensation. In the storage step, the data that have been inversely quantized in the inverse quantization step or the data that have been subjected to motion compensation performed in the motion compensation step are stored. For example, in the case of an intra frame coded image, data that have been inversely quantized in the inverse quantization step are stored without modification. In the case of an inter frame coded image, the data that have been subjected to motion compensation performed in the motion compensation step are stored.

In the division step, data which are stored in the storage step and correspond to image data for one frame are divided into a plurality of areas. In the mean value computation step, a mean value of each data set is computed in the respective areas divided in the division step. In DCT step, the mean values computed in the mean value computation step is subjected to DCT. Among coefficients obtained in the DCT step, a predetermined number of coefficients from the top are stored as color descriptors.

The color characteristic quantity computation method of the invention is not provided with the IDCT section, which is provided for the conventional color characteristic quantity computation method. Therefore, there is no necessity for performing inverse DCT. Even at the time of computation of the mean value, the only requirement is to average data of a volume one-sixty-fourth that required conventionally, thereby diminishing the volume of processing.

In relation to the configuration, when image data serving as an object of processing is intra frame coded image which do not refer to other frame data, data obtained as a result of inverse quantization of the image data in the inverse quantization step are stored. In contrast, when image data serving as an object of processing is inter frame coded image which refer to other frame data, the data that have been subjected to motion compensation through the motion compensation step are stored in the storage step.

In relation to the configuration, the color characteristic quantity processor preferably further comprises a second storage step of storing, as color descriptors, a predetermined number of coefficients from the top among coefficients obtained in the DCT step.

In relation to the configuration, in the division step, an aggregate of data in which data corresponding to image data for one frame are arranged in a matrix pattern is preferably divided into a total of 64 areas; that is, eight equal parts in the vertical and horizontal directions, and a mean value of values represented by the data sets in the respective areas is preferably computed in the mean value computation step.

In relation to the configuration, when the number of pixels in a longitudinal and/or lateral direction of image data for one frame is not a multiple of 8 and when data spreading across other areas are obtained as a result of the image data having been divided into a plurality of areas in the division step, the mean value is computed in the mean value computation step by assigning weights to the data.

### BRIEF DESCRIPTION OF THE DRAWINGS

FIG. 1 is a block diagram showing the configuration of a conventional color characteristic quantity processor;

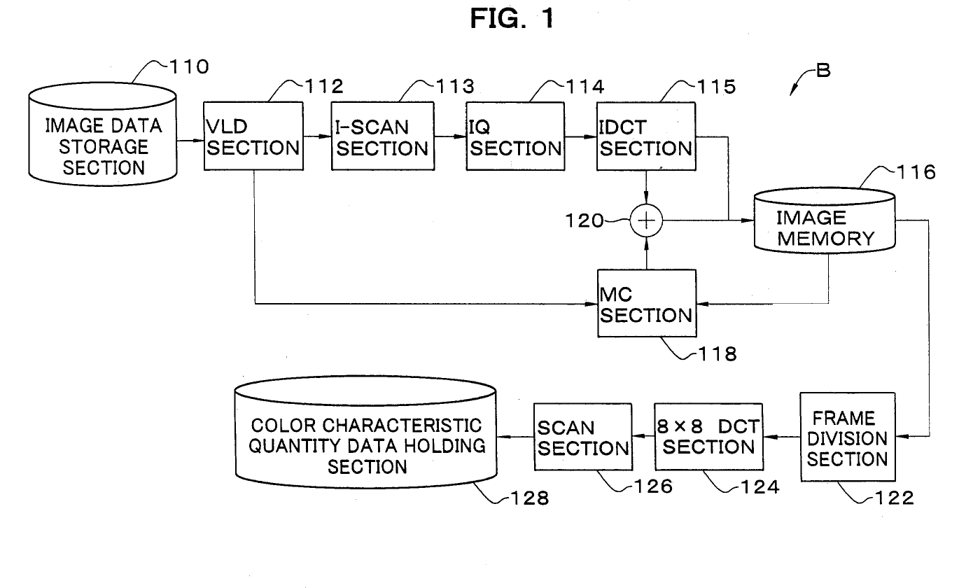

FIG. 2 is a descriptive view for describing the operation of the conventional color characteristic quantity processor;

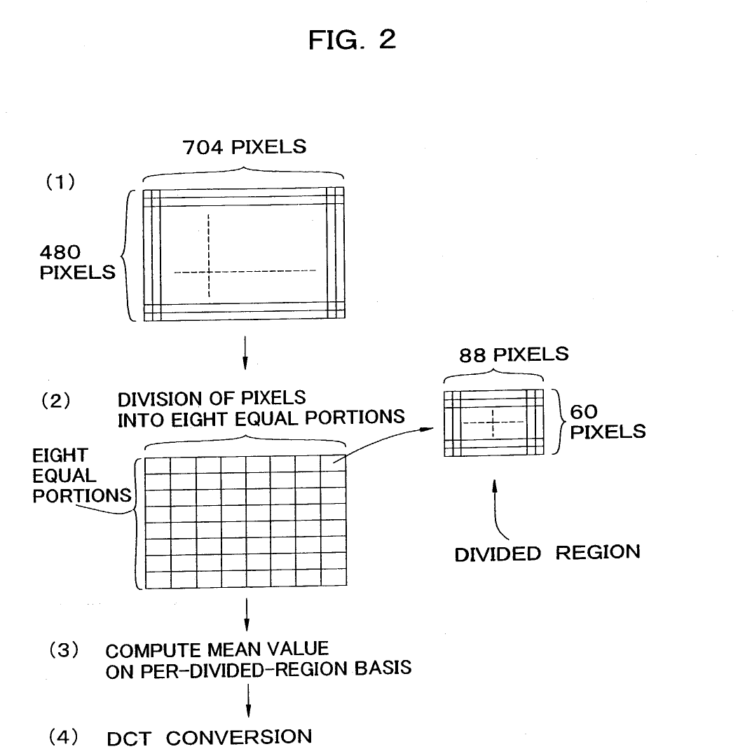

FIG. 3 is a descriptive view for describing operation of the conventional color characteristic quantity processor to be performed when motion compensation is carried out;

FIG. 4 is a block diagram showing the configuration of a color characteristic quantity processor according to an embodiment of the invention;

FIG. 5 is a block diagram showing the configuration of the color characteristic quantity processor according to the embodiment of the invention;

FIG. 6 is a flowchart showing a method for computing a color characteristic quantity according to an embodiment of the invention;

FIG. 7 is a descriptive view for describing operation of the color characteristic quantity processor of the embodiment;

FIG. 8 is a descriptive view for describing operation of the color characteristic quantity processor of the embodiment;

FIG. 9 is a descriptive view for describing operation of the color characteristic quantity processor of the embodiment; and

FIG. 10 is a descriptive view for describing operation of the color characteristic quantity processor of the embodiment to be performed when motion compensation is carried out.

### DESCRIPTION OF THE PREFERRED EMBODIMENT

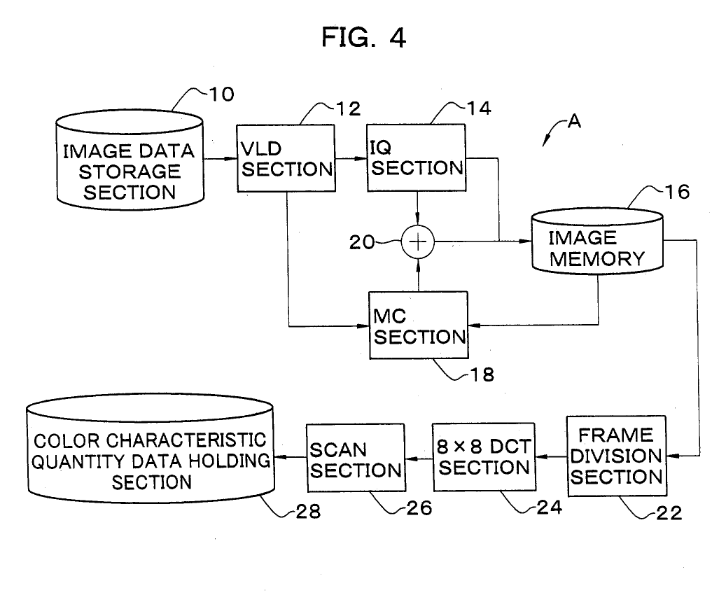

A preferred embodiment of the invention will be described herein below by reference to the drawings. A color characteristic quantity processor A of the embodiment is a device for computing a color descriptor employed for MPEG-7 and configured as shown in FIG. 4. The color characteristic quantity processor A has an image data storage section 10, a VLD section 12, an IQ section (Inverse Quantization) section 14, image memory (storage means) 16, an MC (Motion Compensation) section 18, an addition section 20, a frame division section 22, an 8×8 DCT (Discrete Cosine Transform) section (DCT means) 24, a scan section 26, and a color characteristic quantity data holding section (second storage means) 28.

Here, the image data storage section 10 is a storage device for storing MPEG-coded video image data on a per-frame basis. Static image data maybe stored in the image data storage section 10.

The VLD section 12 subjects the image data stored in the image data storage section 10 to variable-length decoding. The thus-decoded data are output. The VLD section 12 outputs, to the IQ section 14, only DC component data among the data sets that have been subjected to variable-length decoding. Specifically, during demodulation operation, the VLD section 12 decodes AC components as well as the DC components. Only the DC components are output to the IQ section 14. The VLD section 12 serves as the decoding section, and as an extraction section as well.

The IQ (Inverse Quantization) section 14 subjects the data output from the VLD section 12 to inverse quantization. Specifically, the value of the DC component is multiplied in the quantization step.

The image memory 16 stores data pertaining to the inversely-quantized value. In the case of an intra frame coded image such as an I picture [or I-VOP (Video Object Plane)], the data output from the IQ section 14 are stored without modification. In contrast, in the case of an inter frame coded image such as a P-picture or B-picture (or P-VOP or B-VOP), data that have been subjected to motion compensation performed by the MC section 18 and the addition section 20 are stored.

The MC (Motion Compensation) section 18 performs motion compensation operation. On the basis of a motion vector output from the VLD section 12, the MC section 18 extracts a pixel value of a reference frame from the image memory 16, and the thus-extracted pixel value is sent to the addition section 20. The addition section 20 adds the value output from the IQ section 14 to the pixel value of the reference frame and the addition section 20 stores the result of addition in the image memory 16. Thus, the MC section 18 and the addition section 20 act as the motion compensation means.

Here, the image memory 16 has a storage capacity for storing one-sixty-fourth the number of pixels of image data corresponding to one frame. Specifically, under the assumption that the number of pixels of the image data for one frame in a horizontal direction (i.e., the direction X) is taken as P and that the number of pixels of the image data for one frame in a vertical direction (i.e., the direction Y) is taken as Q, the image memory has a storage capacity for storing data of P/8 x Q/8. For instance, when the size of one frame in the image data storage section 10 is 704×480 pixels, a matrix-shaped memory area for storing data corresponding to 88×60 pixels is prepared in the image memory 16. Data corresponding to 88×60 pixels are stored for one frame. The value of one DC component is extracted on each of the pixel blocks arranged in an 8×8 pattern, and the thus-extracted value is inversely quantized. The thus-quantized value is then stored in the image memory 16. Hence, a memory area capable of storing data corresponding to 88×60 pixels is sufficient for one frame.

The frame division section 22 divides the data which correspond to one frame and are stored in the image memory 16 into a total of 64 areas [8 (equal) rows and 8 (equal) columns ], wherein one of the divided areas is taken as a “divided area”) A mean pixel value is computed for each of the divided areas. For instance, when data corresponding to 88×60 pixels are stored in the image memory 16, the data are divided into a total of 64 divided areas [8 (equal) rows and 8 (equal) columns ], and a mean pixel value is computed for each divided block. The frame division section 22 acts as the division means and the mean value computation means.

The 8×8DCT (Discrete Cosine Transform) section 24 subjects the 64 mean values computed by the frame division section 22 to two-dimensional DCT on the basis of the two-dimensional spatial positions.

From among coefficients computed by the 8×8 DCT section 24, the scan section 26 scans several coefficients from the top, and the result of scanning is stored in the color characteristic quantity data holding section 28. The color characteristic quantity data holding section 28 is constituted of a storage device.

The individual sections constituting the color characteristic quantity processor A maybe constituted as a device having these functions. Alternatively, another configuration; for example, the configuration of the color characteristic quantity processor A other than the image data storage section 10, the image memory 16, and the color characteristic quantity data holding section 28, maybe embodied as a program for performing predetermined processing and a CPU for carrying out processing in accordance with the program.

Specifically, when the individual sections of the color characteristic quantity processor A are constituted as devices, the image data storage section 10, the image memory 16, and the color characteristic quantity data holding section 28 are constituted of storage devices, respectively. The VLD section 12, the IQ section 14, the MC section 18, the addition section 20, the frame division section 22, the 8×8 DCT section 24, and the scan section 26 are constituted as a device having those functions.

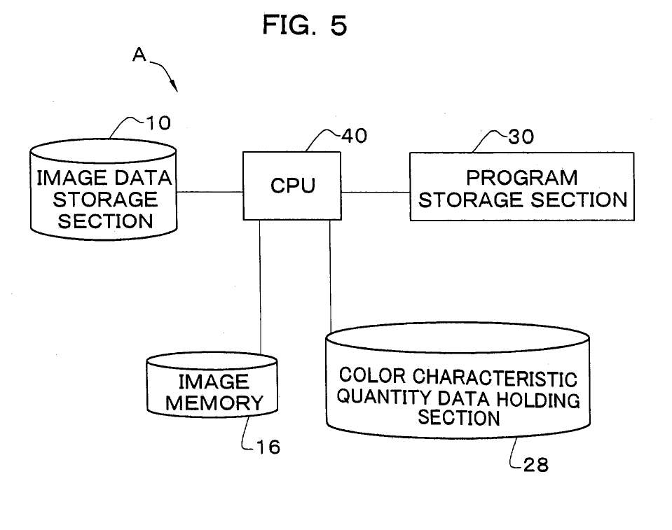

When the configuration of the color characteristic quantity processor A other than portions thereof is constituted by a program for carrying out predetermined processing and a CPU which performs processing in accordance with the program, for example, as shown in FIG. 5, the color characteristic quantity processor A is constituted of the image data storage section 10, the image memory 16, the color characteristic quantity data holding section 28, a program storage section 30, and a CPU 40. The image data storage section 10, the image memory 16, the color characteristic quantity data holding section 28, and the program storage section 30 are constituted of storage devices. Stored in the program storage section 30 are programs for carrying out processing to be performed by the VLD section 12, the IQ section 14, the MC section 18, the addition section 20, the frame division section 22, the 8×8 DCT section 24, and the scan section 26. More specifically, the program storage section 30 stores a program for carrying out processing to be performed by the VLD section 12 (i.e., a program for effecting variable-length decoding (decoding processing) and for extracting DC component (extraction processing)), a program for carrying out processing to be performed by the IQ section 14 (i.e., a program for subjecting the variable-length-decoded data to inverse quantization (inverse quantization processing) and for storing the inverse-quantized value in the image memory 16 (storage processing)), a program for carrying out processing to be performed by the MC section 18 (i.e., a program for effecting motion compensation), a program for carrying out processing to be performed by the addition section 20 (i.e., a program for adding the inversely-quantized value to the pixel value of the reference frame and for storing the result of addition in the image memory 16 (second storage processing))(above motion compensation performed above program and adding act as motion compensation processing), a program for carrying out processing to be performed by the frame division section 22 (i.e., a program for dividing data—which correspond to one frame and are stored in the image memory 16 into a total of 64 areas(division processing)—and computing a mean pixel value for each of the divided areas(mean value computation processing)), a program for carrying out processing to be performed by the 8×8 DCT section 24 (i.e., a program for subjecting the thus-computed respective mean values to a two-dimensional DCT(DCT processing)), and a program for carrying out processing to be performed by the scan section 26 (i.e., a program for scanning several DCT coefficients from the top among the computed DCT coefficients and storing the result of scan into the color characteristic quantity data holding section 28). In relation to the configuration shown in FIG. 5, the program storage section 30 and the CPU 40 correspond to a controller, and the color characteristic quantity data holding section 28 corresponds to a second storage device.

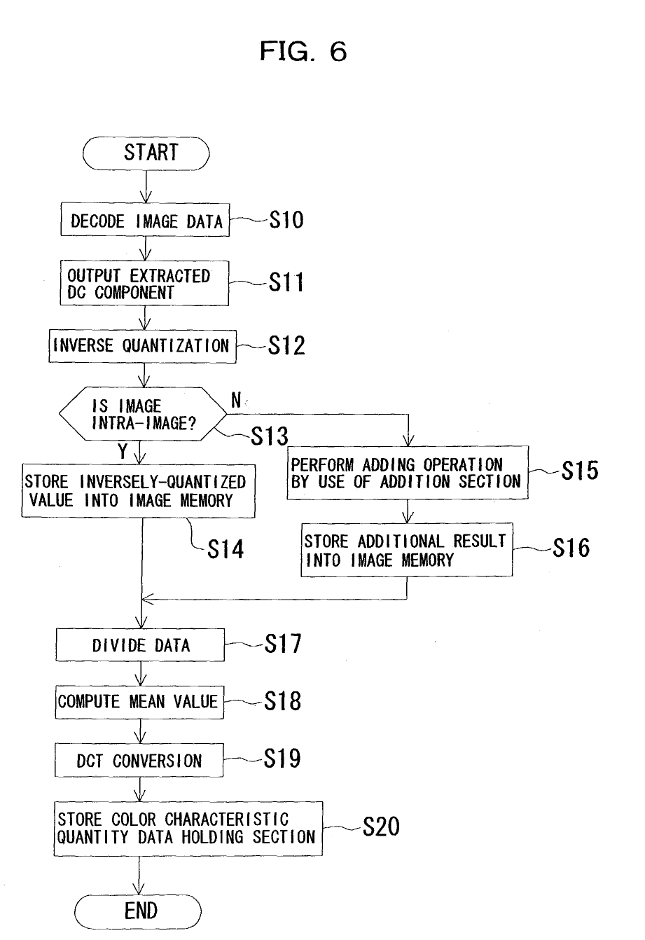

Operation of the color characteristic quantity processor A having the foregoing configuration will now be described by reference to FIG. 6. A method for computing a color characteristic quantity according to the embodiment of the invention will now be described. The VLD section 12 subjects the image data stored in the image data storage section 10 to variable-length decoding (a decoding step, S10). The VLD section 12 extracts only DC component data from among the decoded data and outputs the thus-extracted data to the IQ section 14 (an extraction step, S11). Specifically, the VLD section 12 extracts the value of one DC component on each of the pixel blocks arranged in an 8×8 pattern from among the decoded data and output the extracted data.

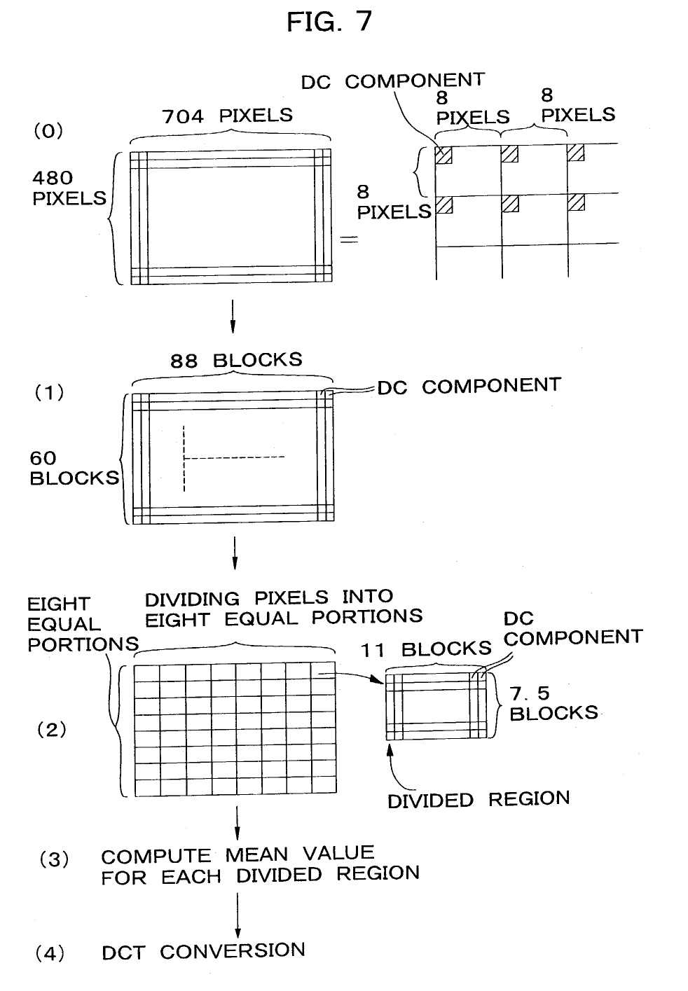

The IQ section 14 subjects the data output from the VLD section 12 to inverse quantization (an inverse quantization step S12) . Specifically, the IQ section 14 performs processing for multiplying the value of the DC component in the quantization step. The inversely-quantized value is output to the image memory 16 or the addition section 20. Specifically, the IQ section 14 outputs data pertaining to the value of the DC component for each set consisting of 8×8 pixels. Therefore, for example, a value corresponding to 88×60 pixels is output for one frame of 704×480 pixels (see (0) and (1) in FIG. 7).

In a case where a frame to be processed (hereinafter called an “object frame”) is an intra frame coded image, the IQ section 14 stores the inversely-quantized value in the image memory 16 without modification (S13, S14). When the object frame is an inter frame coded image, the inversely-quantized value is stored in the image memory 16 after having been subjected to motion compensation. Hence, the IQ section 14 outputs the inversely-quantized value to the addition section 20. In short, the MC section 18 extracts a pixel value of the reference frame from the image memory 16 in accordance with the motion vector sent from the VLD section 12 and outputs the thus-extracted pixel value to the addition section 20. Hence, the addition section 20 adds the data output from the IQ section 14 to the data output from the MC section 18 and outputs a result of addition (motion compensation steps, S13, S15). The result of addition is stored in the image memory 16 (S16). The process for storing data in the image memory 16 corresponds to a storage step.

In connection with the image data corresponding to one frame, data corresponding to one-sixty-fourth the number of pixels of the image data are stored in the image memory 16. For instance, when the size of one frame in the image data storage section 10 is 704×480 pixels, data corresponding to 88×60 pixels are stored in the image memory 16. Here, each data stored in the image memory 16 is taken as a “block.” Further, a value represented by each data stored in the image memory 16 is taken as a “block value.”

The frame division section 22 divides the data stored in the image memory 16 into a total of 64 divided areas (8×8) (a division step, S17) and computes a mean value of the stored value (i.e., a block value) for each divided area (a means value computation step, S18). For example, as mentioned above, when data corresponding to 88×60 pixels are stored in the image memory 16, the data are divided into 64 (8×8 ) divided areas. Data (i.e., 11×7.5 data sets) are stored in one divided area (in other words, 11×7.5 blocks are in one divided area) (see (2) in FIG. 7) . A mean block value is computed for each divided area (see (3) in FIG. 7) . Specifically, 64 mean values are computed.

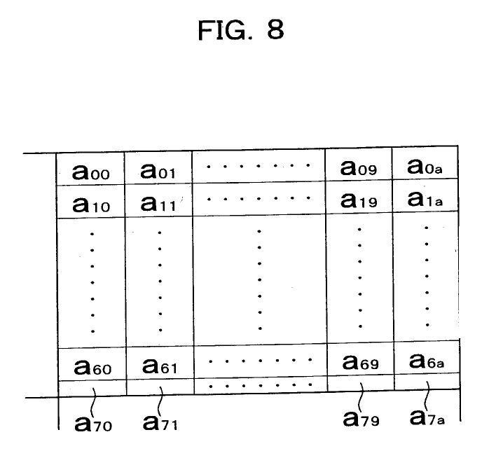

As in the case of the previous example in which the image data for one frame is formed from 704×480 pixels, if the number of pixels in the vertical direction and/or the horizontal direction is not a multiple of 8, data which spread across other divided areas will arise when the data are divided into a plurality of divided areas by means of the frame division section. In such a case, the frame division section 22 computes the mean value computation the mean values by assigning a weight to the data. For instance, when image data for one frame are 704×480 pixels and the data have been equally divided into 64 divided areas, in each of the divided areas the size of each block in a horizontal row includes one-half a block, and hence the block value obtained at that position is computed with one-half weight. As shown in FIG. 8, when data corresponding to 11×7.5 data sets ranging from a₀₀ to a₇ₐ are in one divided area, each of block values a₇₀ to a₇ₐ is computed as 0.5 blocks. Specifically, a mean value of a certain divided area is computed by

$$\frac{\begin{matrix}( {a}_{00} + {a}_{01} + … + {a}_{10} + {a}_{11} + … + \\ {a}_{60} + {a}_{61} + … + 1 / 2 ( {a}_{70} + {a}_{71} + … {a}_{79} + {a}_{7 a} ) )\end{matrix}}{88} .$$

The 8×8 DCT section 24 subjects the 64 mean values to two-dimensional DCT processing, thereby computing a DCT coefficient value (a DCT step, S19) (see (4) in FIG. 7). Subsequently, the scan section 26 arranges the DCT coefficients computed by the 8×8 DCT section 24 in ascending order from a low-frequency term. From among the coefficients, a predetermined number of DCT coefficients from the top are stored as color descriptors in the color characteristic quantity data holding section 28 (second storage step, S20).

According to MPEG-7, the color descriptor performs processing operation for each of the three-dimensional color space axes (Y, Cb, Cr). A color descriptor for a Y signal, a color descriptor for a Cb signal, and a color descriptor for a Cr signal are computed. The thus-computed color descriptors are stored in the color characteristic quantity data holding section 28. A round of processing operations shown in FIG. 6 is for one frame. In the case of image data consisting of a plurality of frames, such as a video image, a round of processing operations shown in FIG. 6 is repeated.

The color descriptors are computed in the manner set forth. Here, the DC component obtained through DCT of a block of 8×8 pixels represents a mean pixel value of the 8×8 pixels before DCT. As mentioned above, the respective DC components output from the VLD section 12 represent respective mean pixel values of the block of 8×8 pixels. Data corresponding to the number of pixels constituting one frame have hitherto been divided into 64 divided areas, and data pertaining to the respective divided areas are averaged. According to the invention, the data pertaining to each of the divided areas are temporarily averaged on a per-8×8-block basis, and a mean value of the block of each divided area is computed. Hence, a result can be said to be substantially the same as that conventionally yielded. Conventionally, when image data for one frame are 704×480pixels, data pertaining to one divided area; that is, data pertaining to 88×60 pixels, are averaged. According to the invention, data pertaining to 88×60 pixels are temporarily averaged on a per-8×8-pixel block (data are averaged on a per-8×4-basis for only a horizontal row) . Each of the 11×7.5 blocks is averaged, and hence a result can be said to be substantially identical with that obtained conventionally even in consideration of the areas corresponding to 0.5 blocks.

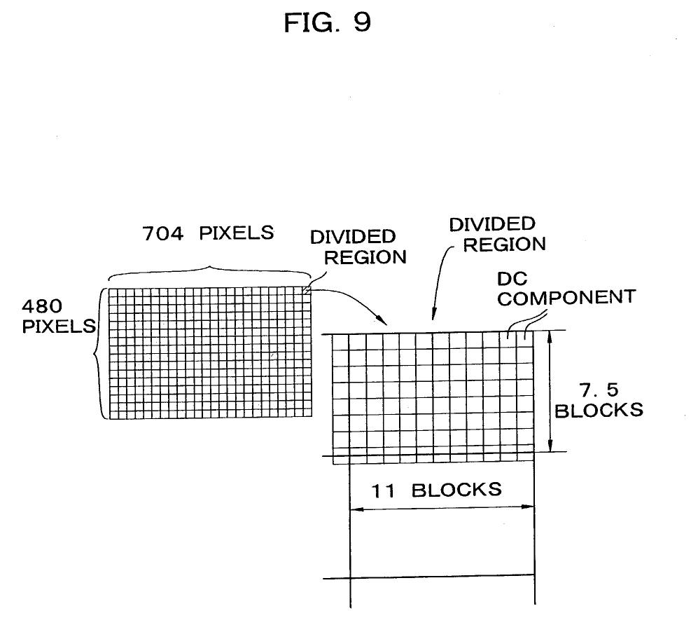

As shown in FIG. 9, one of the 11×7.5 blocks corresponds to a mean value of 8×8 pixels. Hence, one divided area consisting of 11×7.5 blocks is equivalent to the area consisting of 88×60 pixels.

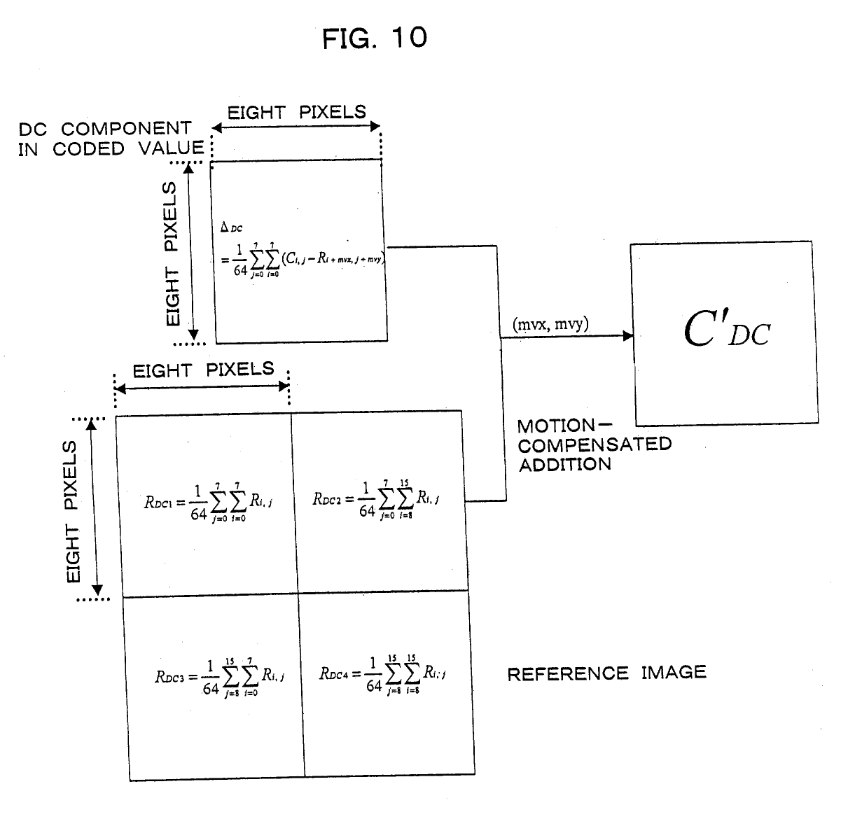

The data that have been subjected to motion compensation can be said to be as follows. As shown in FIG. 10, when a DC component in a certain block of 8×8 pixels is taken as ADC, the value of the DC component is subjected to motion compensation by reference to four blocks of 8×8 pixels, whereby a DC component is obtained. Here, the value of the DC component is assumed to be C′_{DC}, and C′_{DC} can be expressed by Equation (1). Here, in connection with Equation (1), mvx>0 and mvy>0 are set for the sake of simplification.

$$\begin{matrix}{C}_{DC}^{′} = \frac{mvx}{8} \frac{mvy}{8} ( {R}_{DC1} + {Δ}_{DC} ) + \\ \frac{( 8 - mvx )}{8} \frac{mvy}{8} ( {R}_{DC2} + {Δ}_{DC} ) + \\ \frac{mvx}{8} \frac{( 8 - mvy )}{8} ( {R}_{DC3} + {Δ}_{DC} ) + \\ \frac{( 8 - mvx )}{8} \frac{( 8 - mvy )}{8} ( {R}_{DC4} + {Δ}_{DC} )\end{matrix} \qquad Equation ( 1 )$$

A mean value of DC components can be expressed by Equation (2).

$${C}^{′} ave = \frac{1}{MN} {\sum }_{x , y}^{M , N} {C}_{DC ( x , y )}^{′} \qquad Equation ( 2 )$$

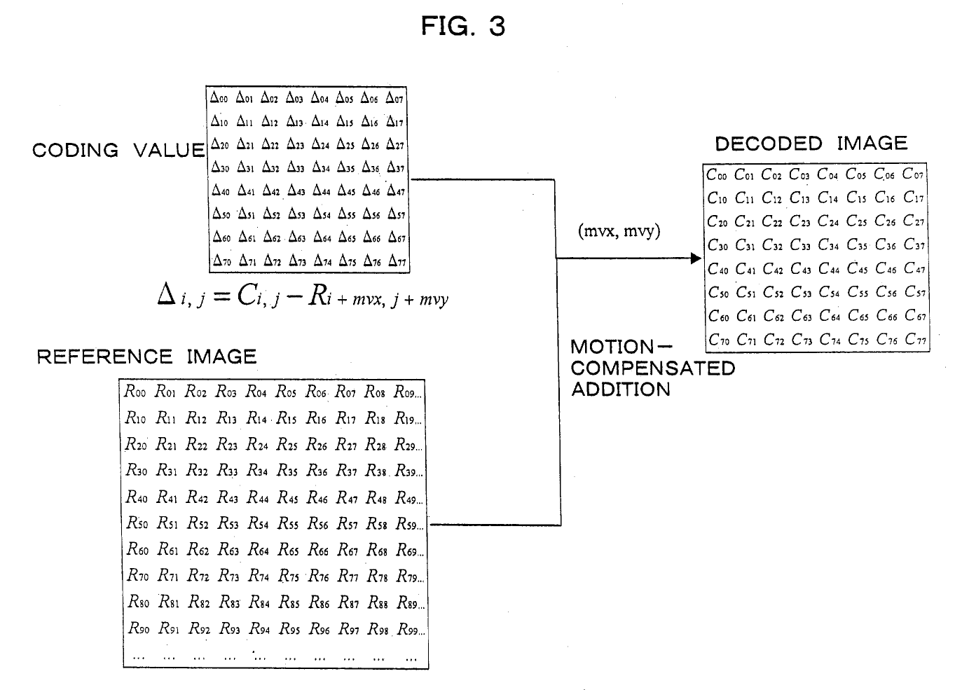

As shown in FIG. 3, the pixel values that have been subjected to motion compensation are conventionally averaged. A mean value computed after division of data corresponding to one frame can be expressed by Equation (3) .

$$\begin{matrix}Cave = \frac{1}{mn} {\sum }_{j = 0}^{n} {\sum }_{i = 0}^{m} {C}_{i , j} \\ = \frac{1}{mn} {\sum }_{j = 0}^{n} {\sum }_{i = 0}^{m} ( {R}_{i + mvx , j + mvy} + {Δ}_{i , j} ) \\ = \frac{1}{MN} {\sum }_{x , y}^{M , N} {C}_{DC ( x , y )} \\ ( {C}_{DC ( x , y )} = {\sum }_{j = y}^{v + s} {\sum }_{i = x}^{x + s} {C}_{i , j} , M = \frac{m}{8} , N = \frac{n}{8} )\end{matrix} \qquad Equation ( 3 )$$

Operation to be performed by the color characteristic quantity processor having the configuration shown in FIG. 5 is the same as that described previously. The CPU 40 performs processing in accordance with the programs stored in the program storage section 30 instead of the VLD section 12, the IQ section 14, the MC section 18 the addition section 20, the frame division section 22, the 8×8 DCT section 24, and the scan section 26 performing processing.

As has been described, the color characteristic quantity processor A is not provided with the IDCT section, which is provided for the conventional color characteristic quantity processor. Therefore, there is no necessity for performing an inverse DCT. Further, data corresponding to 11×7.5blocks are averaged through a process for computing the mean value. Hence, the volume of processing can be reduced. Specifically, the only requirement is to average data in the volume of one-sixty-fourth that required conventionally, thereby diminishing the volume of processing.

The image memory (i.e., the image memory 16) also requires a smaller memory area when compared with that required conventionally. The I-Scan section is not required, nor is the IDCT section required, as mentioned above. Hence, the overall processor can be miniaturized. As mentioned above, an attempt can also be made to curtail the cost of the overall device.

The color characteristic quantity computation method of the invention does not require a step of performing IDCT, which would be required by the conventional method. Even at the time of computation of the mean value, data which are of one-sixty-fourth the conventionally-required volume are averaged. Hence, the volume of processing can be reduced.

The above description has described that the VLD section 12 outputs only DC component data. However, the VLD section 12 may output AC components as well as DC components, and the IQ section 14 may extract solely DC component data from the data output from the VLD section 12 and subject the DC component to inverse quantization.

1. A color characteristic quantity processor for computing color characteristic quantity of image data, comprising:
decoding means for decoding MPEG-coded image data;
extraction means for extracting only DC component data from the data decoded by the decoding means;
inverse quantization means for subjecting the DC component data extracted by the extraction means to inverse quantization;
motion compensation means for subjecting the data that have been inversely quantized by the inverse quantization means to motion compensation;
storage means for storing the data that have been inversely quantized by the inverse quantization means and the data that have been subjected to motion compensation performed by the motion compensation means;
division means which divides, into a plurality of areas, data which are stored in the storage means and correspond to image data for one frame;
mean value computation means for computing a mean value of each data set in the respective areas divided by the division means; and
DCT means for subjecting the mean values computed by the mean value computation means to DCT.

2. The color characteristic quantity processor according claim 1, wherein, when image data serving as objects of processing is intra frame coded image which do not refer to other frame data, the inverse quantization means stores, into the storage means, data obtained through inverse quantization of the intra frame coded image; and, when image data serving as objects of processing is inter frame coded image which refer to other frame data, the inverse quantization means sends data obtained through inverse quantization of the inter frame coded image to the motion compensation means and the motion compensation means stores the data into the storage means after the motion compensation means has subjected the data to motion compensation.

3. The color characteristic quantity processor according to claim 1, further comprising second storage means for storing, as color descriptors, a predetermined number of coefficients from the top among coefficients obtained by the DCT means.

4. The color characteristic quantity processor according to claim 1, wherein the division means divides an aggregate of data in which data corresponding to image data for one frame are arranged in a matrix pattern into a total of 64 areas, that is, eight equal parts in the vertical and horizontal directions, and the mean value computation means computes a mean value of values represented by the data sets in the respective areas.

5. The color characteristic quantity processor according to claim 4, wherein, when the number of pixels in a longitudinal and/or lateral direction of image data for one frame is not a multiple of 8 and when data spreading across other areas are obtained as a result of the division means having divided the image data into a plurality of areas, the mean value computation means computes the mean value by assigning weights to the data.

6. A color characteristic quantity processor for computing color characteristic quantity of image data having a storage device for storing data, and a controller for performing:
decoding processing for decoding MPEG-coded image data;
extraction processing for extracting only DC component data from the data decoded by the decoding processing;
inverse quantization processing for subjecting the DC component data extracted by the extraction processing to inverse quantization;
storage processing for storing, into the storage device, the data inversely quantized by the inversely-quantized when image data serving objects of processing is intra frame coded image which do not refer to other frame data;
motion compensation processing for subjecting the data that have been inversely quantized by the inverse quantization processing to motion compensation when image data serving objects of processing is inter frame coded image which refer to other frame data;
second storage processing for storing into the storage device the data that have been subjected to motion compensation through the motion compensation processing;
division processing for dividing, into a plurality of areas, data which are stored in the storage device and correspond to image data for one frame;
mean value computation processing for computing a mean value of each data set in the respective areas divided by the division processing; and
DCT processing for subjecting the mean values computed by the mean value computation processing to DCT.

7. The color characteristic quantity processor according to claim 6, further comprising a second storage device, and the controller stores, as color descriptors into the second storage device, a predetermined number of coefficients from the top among coefficients obtained by the DCT processing.

8. The color characteristic quantity processor according to claim 6, wherein the controller divides an aggregate of data in which data corresponding to image data for one frame are arranged in a matrix pattern into a total of 64 areas, that is, eight equal parts in the vertical and horizontal directions, through the division processing, and computes a mean value of values represented by the data sets in the respective areas through the mean value computation processing.

9. The color characteristic quantity processor according to claim 8, wherein, when the number of pixels in a longitudinal and/or lateral direction of image data for one frame is not a multiple of 8 and when data spreading across other areas are obtained as a result of the division processing having divided the image data into a plurality of areas, the controller computes the mean value by assigning weights to the data.

10. A color characteristic quantity computation method for computing color characteristic quantity of image data, comprising:
a decoding step of decoding MPEG-coded image data;
an extraction step of extracting only DC component data from the data decoded in the decoding step;
an inverse quantization step of subjecting the DC component data extracted in the extraction step to inverse quantization;
a motion compensation step of subjecting the data that have been inversely quantized in the inverse quantization step to motion compensation;
a storage step of storing the data that have been inversely quantized in the inverse quantization step and the data that have been subjected to motion compensation performed in the motion compensation step;
a division step of dividing, into a plurality of areas, data which are stored in the storage step and correspond to image data for one frame;
a mean value computation step of computing a mean value of each data set in the respective areas divided in the division step; and
a DCT step of subjecting the mean values computed in the mean value computation step to DCT.

11. The color characteristic quantity computation method according to claim 10, wherein, when image data serving as an object of processing is intra frame coded image which do not refer to other frame data, data obtained through inverse quantization of the intra frame coded image are stored in the storage step; and, when image data serving as an object of processing is inter frame coded image which refer to other frame data, the data that have been subjected to motion compensation through the motion compensation step are stored in the storage step.

12. The color characteristic quantity processor according to claim 10, further comprising a second storage step of storing, as color descriptors, a predetermined number of coefficients from the top among coefficients obtained in the DCT step.

13. The color characteristic quantity processor according to claim 10, wherein, in the division step, an aggregate of data in which data corresponding to image data for one frame are arranged in a matrix pattern is divided into a total of 64 areas, that is, eight equal parts in the vertical and horizontal directions, and in the mean value computation step a mean value of values represented by the data sets in the respective areas is computed.

14. The color characteristic quantity processor according to claim 13, wherein, when the number of pixels in a longitudinal and/or lateral direction of image data for one frame is not a multiple of 8 and when data spreading across other areas are obtained as a result of the image data having been divided into a plurality of areas in the division step, the mean value is computed in the mean value computation step by assigning weights to the data.
